(19) United States
(12) Patent Application Publication
(10) Pub. No.: US 2008/0233866 A1
(43) Pub. Date: Sep. 25, 2008

(54) SATELLITE AIDED LOCATION TRACKING AND DATA SERVICES USING GEOSYNCHRONOUS AND LOW EARTH ORBIT SATELLITES

(76) Inventors: Richard Burtner, Ashburn, VA (US); Abdul H. Rana, Great Falls, VA (US)

Correspondence Address: LAW OFFICE OF DUANE S. KOBAYASHI, P.O. Box 4160, Leesburg, VA, 20177, US

(21) Appl. No.: 11/696,713

(22) Filed: Apr. 4, 2007

Related U.S. Application Data
(60) Provisional application No. 60/890,981, filed on Feb. 21, 2007.

(51) Int. Cl. H04B 7/185

(52) U.S. Cl. 455/13.1

(57) ABSTRACT

A system and method for satellite aided location tracking and data services using geosynchronous (GEO) and low earth orbit (LEO) satellites. In one embodiment, a mobile terminal is designed for communication with both GEO and LEO satellites. This dual satellite functionality enables the asset tracking service to provide service across international service areas without hardware modification or reconfiguration of the mobile terminal device.

This application claims priority to provisional application No. 60/890,981, filed Feb. 21, 2007, which is incorporated by reference herein, in its entirety, for all purposes.

### BACKGROUND

1. Field of the Invention

The present invention relates generally to monitoring and tracking and, more particularly, to a satellite aided location tracking and data services using geosynchronous (GEO) and low earth orbit (LEO) satellites.

2. Introduction

Tracking mobile assets represents a growing enterprise as companies seek increased visibility into the status of movable assets (e.g., trailers, containers, etc.). Visibility into the status of movable assets can be gained through mobile terminals that are affixed to the assets. These mobile terminals can be designed to generate position information that can be used to update status reports that are provided to customer representatives.

Mobile terminals can report this position information to a centralized location via a wireless communication network such as a satellite communication network. In general, satellite communication networks provide excellent monitoring capabilities due to their wide-ranging coverage, which can span large sections of a continent. In providing an asset tracking service that can be applied to multiple international markets, it would be desirable to have a mobile terminal that is designed for flexible configuration. This flexible configuration would enable the mobile terminal to operate with various satellite communication systems in operation in the multiple international markets, thereby decreasing the time to market of such devices. What is needed therefore is a single mobile terminal design that enables a mobile terminal to operate with a plurality of distinct satellite communication networks.

### SUMMARY

A system and method that enables satellite aided location tracking and data services using geosynchronous (GEO) and low earth orbit (LEO) satellites, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a satellite network in communication with a mobile terminal on an asset.

FIG. 2 illustrates an embodiment of a mobile terminal in communication with multiple satellite networks.

FIG. 3 illustrates an embodiment of a mobile terminal.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

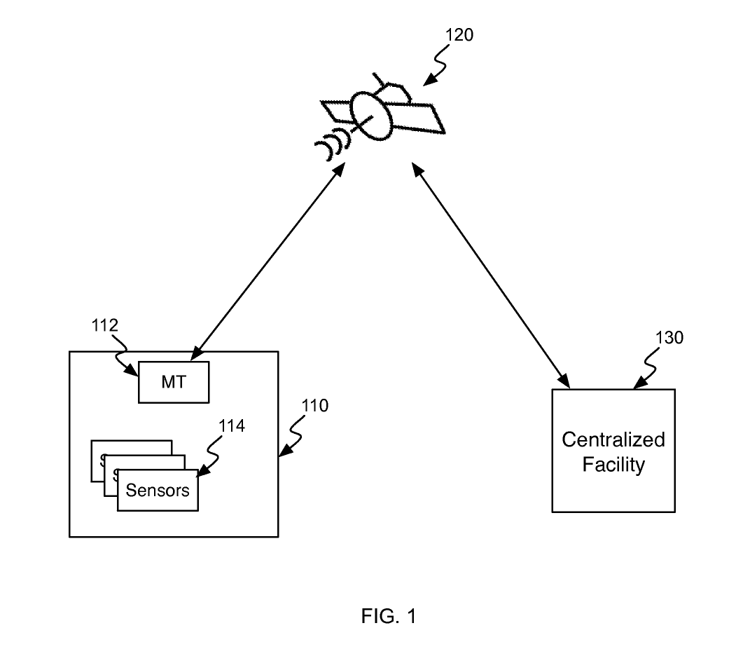

FIG. 1 illustrates an embodiment of a conventional asset tracking system that can be used to track the positions of assets. As illustrated, the asset tracking system includes a mobile terminal 112 that is positioned on an asset 110. As would be appreciated, asset 110 can be embodied in various forms such as a trailer, a railcar, a shipping container, or the like.

In one embodiment, mobile terminal 112 is designed to receive global positioning system (GPS) signals from a plurality of GPS satellites (not shown). Reception of these GPS signals enables mobile terminal 112 to generate position information. In one embodiment, this position information represents a calculated position solution of mobile terminal 112, and hence asset 110. In another embodiment, this position information represents information that can be used by centralized facility 240 to calculate a position solution. Regardless of the position information that is generated by mobile terminal 112, centralized facility 240 can be responsible for reporting the current and historical positions of asset 110.

In meeting the demand by customers for greater visibility into the status of assets, the asset-tracking system can also include one or more sensors 114 that are affixed to those assets. Various sensor types can be used. For example, volume sensors, temperature sensors, chemical sensors, radiation sensors, weight sensors, light sensors, water sensors, etc. can be used to report the condition of cargo being transported or an environment of the asset. In another example, truck cab ID indicators, odometer sensors, wheel sensors, vibration sensors, etc. can be used to report the condition of the service vehicle. In general, these various sensors can be used to report status information or the occurrence of any events at the service vehicle to the mobile terminal for transmission to the centralized facility.

The position information along with any sensor information can be reported to the centralized facility periodically, upon request, or upon an occurrence of a detected event at the asset location. As illustrated in FIG. 1, these reports are sent via communication satellite 120. In one embodiment, communication satellite 120 is a geosynchronous or geostationary (GEO) satellite that is positioned a fixed point at approximately 22,000 miles above the earth's surface. At this fixed height, the GEO satellite matches the Earth's rotation speed and is therefore in a fixed position in space in relation to the earth's surface. The satellite goes around once in its orbit for every rotation of the earth.

While a single GEO satellite can cover as much as 40 percent of the earth's surface, a GEO satellite can typically be configured to focus its transmission and increase its signal strength over a defined service area. These large service areas can still dictate that a mobile terminal is configured to communicate with a single GEO satellite.

In providing mobile terminal tracking and data services to customers that span international boundaries, the design of a mobile terminal for operation solely with GEO satellites can lead to competitive disadvantages. For example, mobile terminal tracking and data services in a different GEO communication satellite service area would often require the negotiation of agreements with different communication satellite service providers. These international negotiations can unnecessarily hinder or delay the introduction of mobile terminal services across an entire international marketplace.

In accordance with the present invention, the mobile terminal can be designed to communicate with multiple satellite communication networks, thereby increasing its flexibility in communicating in different international service areas. In one embodiment, a hybrid mobile terminal is provided that also includes the capability to communicate with low earth orbit (LEO) satellites. In general, LEO satellites orbit the earth at an orbit below the GEO satellite orbit and are not fixed in space in relation to the rotation of the earth. LEO satellites can move at very high speeds such that a LEO satellite can go across the visible horizon in a short period of time (e.g., approximately 10 minutes). When the first LEO satellite moves out to the horizon, another LEO satellite becomes available for communication. Because of the low orbit, the mobile terminal transmitter does not have to be as powerful as compared to transmitting to GEO satellites.

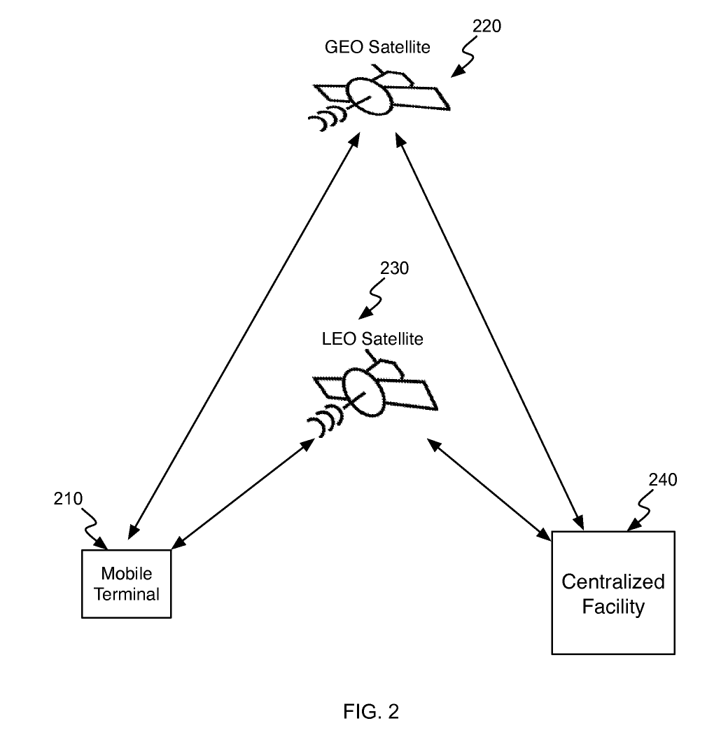

FIG. 2 illustrates a mobile terminal that is designed for communication with multiple satellite communication networks. As illustrated, mobile terminal 210 can communicate with centralized facility via either GEO satellite 220 or LEO satellite 230. It is a feature of the present invention that the inclusion of LEO satellite communication functionality into a mobile terminal along with GEO satellite communication functionality enables the asset tracking service provider to provide service across international service areas without hardware modification or reconfiguration of the mobile terminal device. This results since the mobile terminal can be flexibly configured to operate in various modes.

In one operation mode, the mobile terminal can be configured to operate solely with a GEO satellite. For example, this operation mode can be selected for a mobile terminal when a suitable GEO satellite service provider is available for a particular service area in which the mobile terminal will be employed. In another operation mode, the mobile terminal can be configured to operate solely with a LEO satellite. For example, this operation mode can be selected for a mobile terminal when a suitable LEO satellite service provider is available for all service areas. In yet another operation mode, the mobile terminal can be configured to operate in a hybrid mode where both GEO and LEO satellites are used. For example, this hybrid operation mode can be selected where mobile terminals receive configuration information or reference information (e.g., pilot signal) via a GEO satellite, but transmit position information and/or sensor information to a centralized facility via a LEO satellite. In one scenario, this hybrid operation mode can be selected where the cost of transmission over a LEO satellite is lower than a GEO satellite, or the communications performance on the LEO satellite is better than on the GEO satellite.

In general, the flexibility in selection of mobile terminal operating mode enables a single mobile terminal hardware design to be applied across all international service areas. In other words, the mobile terminal hardware design would not be dictated by the ability of the asset tracking service provider to negotiate suitable agreements with the particular satellite service providers that serve a particular service area. Significantly, a feature of the present invention is that it obviates the need to negotiate new agreements with additional GEO satellite service providers prior to entry into a new market.

Asset tracking service providers are then given the flexibility to rapidly introduce new service offerings to international customers. In one example, new service agreements completed after deployment of the mobile terminal can still be accommodated through the reconfiguration of the mobile terminal to operate in a different mode. As would be appreciated, reconfiguration could enable the mobile terminal to switch between GEO only, LEO only, or hybrid GEO/LEO modes.

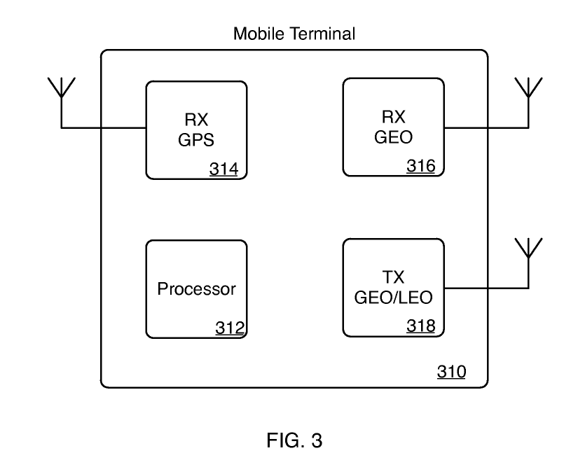

As noted above, a hybrid mobile terminal device that enables communication with either a GEO satellite system or a LEO satellite system enables flexibility in provisioning and potential reduction in costs. FIG. 3 illustrates an embodiment of a mobile terminal that is designed to communicate with both a GEO satellite system and a LEO satellite system. As illustrated, mobile terminal 310 includes processor 312 that is operative to control various transmit and receive modules. In one embodiment, mobile terminal 310 includes one transmit module 318 and two receive modules 314 and 316.

Receive module 314 is designed to receive GPS satellite signals that are used to generate position information, while receive module 316 is designed to receive GEO satellite signals. Transmit module 318, on the other hand, is an integrated module that is designed to transmit to either a GEO satellite or a LEO satellite. In one embodiment, transmit module 318 is separated into two distinct transmit modules.

In the illustration of FIG. 3, each of the modules is shown as being coupled to a separate antenna. As would be appreciated, modules can also be designed to share an antenna.

With this configuration, the mobile terminal can be configured in multiple operation modes as described above. In a GEO mode, receive module 316 and transmit module 318 (with GEO) would be used for GEO receiving and transmitting, respectively. In a LEO mode, transmit module 318 could be used for LEO transmitting. This mode can be used when only LEO transmissions would occur, for example, to report a full GPS derived position. Finally, in a hybrid mode, receive module 316 and transmit module 318 (with LEO) would be used for GEO receiving and LEO transmitting, respectively. In this mode, the GEO receiving can enable configuration or reference information to be received by the mobile terminal. It should be noted that in one embodiment, the mobile terminal can also include a LEO receive module that is either integrated with the GEO receive module or as a separate module.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A mobile terminal, comprising:
a first receiver for receiving signals from a plurality of global positioning system satellites;
a second receiver for receiving signals from a geosynchronous satellite; and
a transmitter module that includes a geosynchronous satellite transmitter and a low earth orbit satellite transmitter, wherein the mobile terminal selectively transmits, under control of a processor, position information to a centralized location via one of a geosynchronous satellite and a low earth orbit satellite.

2. The mobile terminal of claim 1, wherein said second receiver receives configuration information from said geosynchronous satellite.

3. The mobile terminal of claim 1, wherein said second receiver receives reference information in a pilot signal from said geosynchronous satellite.

4. The mobile terminal of claim 3, wherein said geosynchronous satellite transmitter is deactivated.

5. The mobile terminal of claim 1, wherein said transmitter module transmits a calculated position.

6. The mobile terminal of claim 1, wherein said transmitter module transmits position information that enables said centralized location to calculate a position.

7. The mobile terminal of claim 1, wherein a selection of one of said geosynchronous satellite transmitter and said low earth orbit satellite transmitter occurs at a time proximate to activation of the mobile terminal.

8. The mobile terminal of claim 1, wherein a selection of one of said geosynchronous satellite transmitter and said low earth orbit satellite transmitter occurs in a reconfiguration process after activation.

9. A mobile terminal, comprising:
a first receiver for receiving signals from a plurality of global positioning system satellites;
a second receiver for receiving signals from a geosynchronous satellite; and
a low earth orbit satellite transmitter that transmits position information to a centralized location via a low earth orbit satellite.

10. The mobile terminal of claim 9, wherein said second receiver receives configuration information from said geosynchronous satellite.

11. The mobile terminal of claim 9, wherein said second receiver receives reference information in a pilot signal from said geosynchronous satellite.

12. The mobile terminal of claim 9, wherein said low earth orbit transmitter transmits a calculated position.

13. The mobile terminal of claim 9, wherein said low earth orbit transmitter transmits position information that enables said centralized location to calculate a position.

14. A satellite communication method, comprising:
receiving global positioning system signals from a plurality of global positioning system satellites;
receiving signals from a geosynchronous satellite; and
transmitting position information derived from said received global positioning system signals to a centralized location via a low earth orbit satellite.

15. The method of claim 14, wherein said receiving from said geosynchronous satellite comprises receiving configuration information.

16. The method of claim 14, wherein said receiving from said geosynchronous satellite comprises receiving reference information in a pilot signal.

17. The method of claim 14, wherein said transmitting comprises transmitting a calculated position.

18. The method of claim 14, wherein said transmitting comprises transmitting position information that enables said centralized location to calculate a position.
